(19) United States
(12) Patent Application Publication
(10) Pub. No.: US 2026/0134496 A1
(43) Pub. Date: May 14, 2026

(54) LICENSE ISSUING METHOD, OPERATION TERMINAL, AND RECORDING MEDIUM

(71) Applicant: Panasonic Intellectual Property Management Co., Ltd., Osaka (JP)

(72) Inventors: Eiichi MURAMOTO, Kanagawa (JP); Nobuaki Tasaki, Osaka (JP); Motoshi Anabuki, Hyogo (JP)

(21) Appl. No.: 19/434,824

(22) Filed: Dec. 29, 2025

Related U.S. Application Data
(63) Continuation of application No. PCT/JP2024/017903, filed on May 15, 2024.

(30) Foreign Application Priority Data
Jul. 10, 2023 (JP) 2023-112935

(51) Int. Cl. G06Q 50/26; G06Q 20/10

(52) U.S. Cl. CPC G06Q 50/26; G06Q 20/102

(57) ABSTRACT

A license issuing method includes: obtaining first information that includes: a test result that includes an operation history of an application that implements a test for issuing the license, operator information, service provider information for identifying a service provider that provides a remote system for the mobile body, administrator information for identifying an administrator that conducts a review to determine whether the test is appropriate and issues the license, and test information for identifying the test approved through the review by the administrator; when the test result included in the first information satisfies a predetermined standard, generating license information for identifying the license that is issued to the operator identified by the operator information included in the first information and is for the remote operation that corresponds to the test identified by the test information; and issuing the license by outputting the license information.

### CROSS REFERENCE TO RELATED APPLICATIONS

This is a continuation application of PCT International Application No. PCT/JP 2024/017903 filed on May 15, 2024, designating the United States of America, which is based on and claims priority of Japanese Patent Application No. 2023-112935 filed on Jul. 10, 2023. The entire disclosures of the above-identified applications, including the specifications, drawings and claims are incorporated herein by reference in their entirety.

### FIELD

The present disclosure relates to a license issuing method, an operation terminal, and a recording medium.

### BACKGROUND

Patent Literature (PTL) 1 discloses a license integration system that manages a plurality of licenses in an integrated manner.

### CITATION LIST

### Patent Literature

PTL 1: Japanese Unexamined Patent Application Publication No. 2017-107400

### SUMMARY

### Technical Problem

The present disclosure provides a license issuing system and so forth that make it easier to issue a license for remote operation that satisfies a prescribed or higher standard of operation skills and that can be used for other remote operation systems as well.

### Solution to Problem

A license issuing method according to one aspect of the present disclosure is a license issuing method to be executed by a license issuing device that issues a license for remote operation of a mobile body to an operator of the mobile body, and the license issuing method includes: obtaining first information that includes: a test result that includes an operation history of an application that implements a test for issuing the license for the remote operation; operator information for identifying the operator; service provider information for identifying a service provider that provides a remote system for the mobile body; administrator information for identifying an administrator that conducts a review to determine whether the test is appropriate and issues the license; and test information for identifying the test approved through the review by the administrator; when the test result included in the first information satisfies a predetermined standard, generating license information for identifying the license that is issued to the operator identified by the operator information included in the first information and is for the remote operation that corresponds to the test identified by the test information; and issuing the license by outputting the license information.

Meanwhile, an operation terminal according to one aspect of the present disclosure is an operation terminal to be connected, via a network, to a license issuing device that issues a license for remote operation of a mobile body to an operator of the mobile body, and the operation terminal includes: a receiver that receives, from the license issuing device, first user interface (UI) information representing a first UI of a first application that implements a test for issuing the license for the remote operation; an acceptor that accepts a first operation for the remote operation input by the operator via the first UI; and a transmitter that transmits, to the license issuing device, operation information representing the first operation accepted by the acceptor, wherein the receiver receives license information for identifying the license for the remote operation issued when a test result including an operation history that is based on the operation information satisfies a predetermined standard.

It is to be noted that general or specific embodiments of the above may be implemented in the form of a system, an apparatus, an integrated circuit, a computer program, or a computer readable recording medium, such as a compact disc-read only memory (CD-ROM), or through any desired combinations of a system, an apparatus, an integrated circuit, a computer program, and a recording medium.

### Advantageous Effects

The present disclosure makes it easier to issue a license for remote operation that satisfies a prescribed or higher standard of operation skills and that can be used for other remote operation systems as well.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a drawing showing one example of a configuration of a management system according to an embodiment.

FIG. 2 is a drawing showing one example of a configuration of a service provider terminal according to the embodiment.

FIG. 3 is a drawing showing one example of a configuration of an operation terminal according to the embodiment.

FIG. 4 is a drawing showing one example of a configuration of an administrator terminal according to the embodiment.

FIG. 5 is a drawing showing one example of a configuration of a license issuing device according to the embodiment.

FIG. 6 is a drawing for describing an overview of a license issuing method executed in the management system according to the embodiment.

FIG. 7 is a drawing showing an example of a test result.

FIG. 8 is a drawing showing an example of an operation history.

FIG. 9 is a sequence diagram showing one example of a license issuing process executed by the management system according to the embodiment.

FIG. 10 is a drawing showing one example of a controller to be connected to the operation terminal.

FIG. 11 is a drawing showing one example of a user interface (UI) displayed on the operation terminal.

FIG. 12 is a drawing showing another example of the UI displayed on the operation terminal.

FIG. 13A is a drawing showing a first example of a moving route set in advance to be used in a test.

FIG. 13B is a drawing showing a second example of the moving route set in advance to be used in a test.

FIG. 13C is a drawing showing a third example of the moving route set in advance to be used in a test.

FIG. 13D is a drawing showing a fourth example of the moving route set in advance to be used in a test.

FIG. 14 is a drawing for describing an overview of a license issuing method executed in a management system according to Variation (1).

FIG. 15 is a drawing for describing a system that allows a certified operator to intervene in an operation of an operator holding a provisional license.

FIG. 16 is an explanatory diagram showing a data structure of a blockchain.

FIG. 17 is an explanatory diagram showing a data structure of transaction data.

FIG. 18 is an explanatory diagram showing transaction data that pertains to the execution of a smart contract.

FIG. 19 is an explanatory diagram showing a process that pertains to the execution of the smart contract.

### DESCRIPTION OF EMBODIMENT

### Underlying Knowledge Forming Basis of the Present Disclosure

A license for remotely operating a mobile body may be issued by each of the service providers that provide remote operation systems. In that case, if a person is to operate mobile bodies via a plurality of remote operation systems provided by a plurality of service providers, that person needs a plurality of licenses, and this leads to poor user-friendliness. Meanwhile, if, in an effort for improved user-friendliness, a license for a remote operation system provided by one service provider is to be used also as a license for a different remote operation system provided by a different service provider, there needs to be a prescribed or higher standard set for the operation skills required for each license.

The technology disclosed in PTL 1 fails to take the problem above into consideration.

Accordingly, through diligent examinations, the present inventors have conceived of a license issuing system and so forth that make it easier to issue a license for remote operation that satisfies a prescribed or higher standard of operation skills and that can be used for other remote operation systems as well.

A license issuing method according to a first aspect of the present disclosure is a license issuing method to be executed by a license issuing device that issues a license for remote operation of a mobile body to an operator of the mobile body, and the license issuing method includes: obtaining first information that includes: a test result that includes an operation history of an application that implements a test for issuing the license for the remote operation; operator information for identifying the operator; service provider information for identifying a service provider that provides a remote system for the mobile body; administrator information for identifying an administrator that conducts a review to determine whether the test is appropriate and issues the license; and test information for identifying the test approved through the review by the administrator; when the test result included in the first information satisfies a predetermined standard, generating license information for identifying the license that is issued to the operator identified by the operator information included in the first information and is for the remote operation that corresponds to the test identified by the test information; and issuing the license by outputting the license information.

According to this configuration, if the test result of the test approved through the review by the administrator satisfies the predetermined standard, the license is issued to the operator who has taken the test. Therefore, this configuration makes it easier to issue a license for remote operation that satisfies a prescribed or higher standard of operation skills and that can be used for other remote operation systems as well.

A license issuing method according to a second aspect of the present disclosure is the license issuing method according to the first aspect in which the license issuing method is executed by each of a plurality of license issuing devices that include the license issuing device, the plurality of license issuing devices each manage a plurality of distributed ledgers, the first information is first transaction data, the plurality of distributed ledgers each include a first contract code for generating the license information based on the first transaction data, and in the generating of the license information, in response to the first transaction data being obtained, the license information is generated by executing the first contract code included in a first distributed ledger managed by the license issuing device among the plurality of distributed ledgers.

According to this configuration, since the license information is generated as the first contract code is executed, this configuration can prevent the license information from being generated in a fraudulent manner.

A license issuing method according to a third aspect of the present disclosure is the license issuing method according to the second aspect, and the license issuing method further includes: obtaining second transaction data that includes review information for identifying the review through which the test has been approved as being appropriate, and review target information for identifying the test subjected to the review identified by the review information; and generating the test information for identifying the test identified by the review target information, based on the second transaction data, wherein the plurality of distributed ledgers each include a second contract code for generating the test information based on the second transaction data, and in the generating of the test information, in response to the second transaction data being obtained, the test information is generated by executing a second contract code included in the first distributed ledger.

According to this configuration, since the test information is generated as the second contract code is executed, this configuration can prevent the test information from being generated in a fraudulent manner.

A license issuing method according to a fourth aspect of the present disclosure is the license issuing method according to the second aspect or the third aspect in which the first contract code further executes a transfer of a payment of a test fee for the test taken by the operator from an account of the operator to at least one of an account of the administrator or an account of the service provider.

According to this configuration, since the transfer of the payment of the test fee is executed as the first contract code is executed, this configuration makes it possible to execute the transfer of the payment of the test fee without fraud.

A license issuing method according to a fifth aspect of the present disclosure is the license issuing method according to any one of the second aspect to the fourth aspect, and the license issuing method further includes: generating a first block that includes the first transaction data and storing the first block in the plurality of distributed ledgers.

According to this configuration, since the first block that includes the first transaction data is stored in the distributed ledgers, this configuration can prevent the first information that includes the test result from being altered.

A license issuing method according to a sixth aspect of the present disclosure is the license issuing method according to any one of the second aspect to the fifth aspect, and the license issuing method further includes: generating a second block that includes the second transaction data and storing the second block in the plurality of distributed ledgers.

According to this configuration, since the second block that includes the license information is stored in the distributed ledgers, this configuration can prevent the license information from being altered.

A license issuing method according to a seventh aspect of the present disclosure is the license issuing method according to any one of the first aspect to the sixth aspect in which a first license for first remote operation and a second license for second remote operation of a type different from a type of the first remote operation are issuable by the license issuing method, a first remote system for the first remote operation is provided by a first service provider, a second remote system for the second remote operation is provided by a second service provider, and in the generating of the license information, the predetermined standard is determined to be satisfied when a first test result of a first test for issuing the first license satisfies a first standard, and the predetermined standard is determined to be satisfied when a second test result of a second test for issuing the second license satisfies the first standard.

According to this configuration, the first license and the second license can be managed in an integrated manner.

A license issuing method according to an eighth aspect of the present disclosure is the license issuing method according to any one of the first aspect to the seventh aspect, and the license issuing method further includes: successively accepting, via an operator terminal, an operation for the remote operation input by the operator via a user interface (UI) of the application; and generating the operation history by recording a plurality of operations obtained in the successively accepting.

According to this configuration, the operation history that is based on the plurality of operations received from the operation terminal can be generated, and whether the predetermined standard is satisfied can be determined based on the test result that includes the generated operation history.

A license issuing method according to a ninth aspect of the present disclosure is the license issuing method according to the eighth aspect in which the test result includes a score calculated based on the operation history, and when the score is higher than or equal to a reference value serving as the predetermined standard, the test result is determined to satisfy the predetermined standard.

According to this configuration, by determining whether the score calculated based on the operation history exceeds the reference value, whether the test result satisfies the predetermined standard can be determined.

A license issuing method according to a tenth aspect of the present disclosure is the license issuing method according to the eighth aspect or the ninth aspect, and the license issuing method further includes: obtaining the license information from the operator terminal; and permitting the remote operation of a mobile body that corresponds to the license information among a plurality of mobile bodies, the remote operation being performed via the operator terminal.

This configuration makes it easier to permit the remote operation of the mobile body that corresponds to the license information.

An operation terminal according to an eleventh aspect of the present disclosure is an operation terminal to be connected, via a network, to a license issuing device that issues a license for remote operation of a mobile body to an operator of the mobile body, and the operation terminal includes: a receiver that receives, from the license issuing device, first user interface (UI) information representing a first UI of a first application that implements a test for issuing the license for the remote operation; an acceptor that accepts a first operation for the remote operation input by the operator via the first UI; and a transmitter that transmits, to the license issuing device, operation information representing the first operation accepted by the acceptor, wherein the receiver receives license information for identifying the license for the remote operation issued when a test result including an operation history that is based on the operation information satisfies a predetermined standard.

According to this configuration, since the operation information representing the first operation performed on the first application that implements the test for issuing the license is transmitted and the license information that is based on the operation information is received, the license can be obtained with ease.

An operation terminal according to a twelfth aspect of the present disclosure is the operation terminal according to the eleventh aspect, and the operation terminal further includes: a storage that stores license information for identifying the license that is issued to the operator and is for the remote operation corresponding to the test, wherein the transmitter further transmits the license information to the license issuing device, the receiver receives, from the license issuing device, second UI information representing a second UI of a second application for the remote operation of the mobile body corresponding to the license information among a plurality of mobile bodies, the acceptor accepts a second operation for the remote operation input by the operator via the second UI, and the transmitter transmits, to the license issuing device, operation information representing the second operation accepted by the acceptor.

According to this configuration, since the remote operation of the mobile body that corresponds to the license information issued to the operator is permitted, this configuration allows, with ease, the operator to operate an appropriate mobile body according to the license that the operator has obtained.

A recording medium according to a thirteenth aspect of the present disclosure is a non-transitory computer readable recording medium having recorded thereon a program for causing a computer to execute the license issuing method according to any one of the first aspect to the tenth aspects.

Hereinafter, an embodiment will be described with reference to the drawings. It is to be noted that the embodiment described hereinafter merely illustrates a specific example of the present disclosure. In other words, the numerical values, the shapes, the materials, the constituent elements, the arrangement and the connection modes of the constituent elements, the steps, the order of the steps, and so on illustrated according to the following embodiment are examples and are not intended to limit the present disclosure. Moreover, of the constituent elements described according to the following embodiment, any constituent elements that are not cited in the independent claims expressing the broadest concept are not necessarily required in order to solve the problem faced by the present disclosure but are construed as constituent elements that form a more preferable embodiment.

### Embodiment

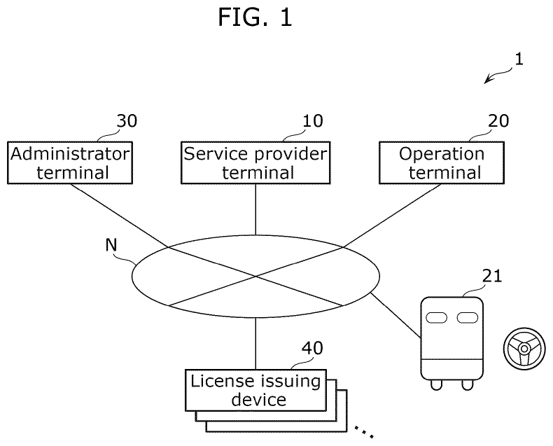

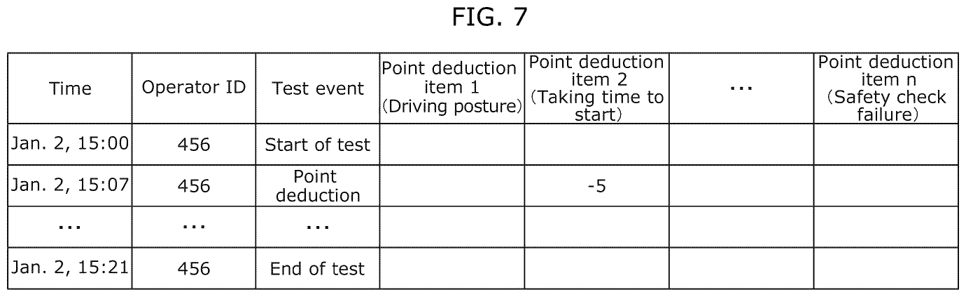

First, a system configuration according to the present disclosure will be described with reference to FIG. 1 to FIG. 6.

A management system according to the present disclosure includes three or more terminals to be used by respective users and one or more authentication servers. The management system allows auditing of a newly entered contract, that is, auditing of the content of the contract and stores the contract validated as the result of the audit into a ledger. Hereinafter, a configuration and so on of the management system according to the present embodiment will be described with reference to some drawings.

### 1. Management System

FIG. 1 is a drawing showing one example of a configuration of a management system according to an embodiment.

As shown in FIG. 1, management system 1 according to the present embodiment includes, for example, service provider terminal 10, operation terminal 20, administrator terminal 30, a plurality of license issuing devices 40, and mobile body 21. These components are connected to each other via network N. While network N is, for example, the internet or a mobile phone carrier network, network N may be any communication circuit or network.

Service provider terminal 10 will be described below.

### Service Provider Terminal 10

Service provider terminal 10 is one example of a terminal used by a service provider. The service provider provides a remote system for mobile body 21. Mobile body 21 may be, for example, a self-driving vehicle, including an autonomous delivery robot, or an unmanned aerial vehicle, such as a drone. Mobile body 21 is a device whose movement is controlled remotely (this control pertaining to the movement is referred to as “movement control” in the following description). The movement control includes, for example, control of the moving direction and control of the moving speed. Mobile body 21, for example, receives control information representing an instruction for movement control from operation terminal 20 serving as a remote monitoring device and executes the movement control in accordance with the received control information. Furthermore, mobile body 21 transmits detection information detected by a plurality of kinds of sensors provided in mobile body 21 to operation terminal 20 via wireless communication. Operation terminal 20 accepts an operation for providing an instruction for movement control in real time and presents detection information to the operator of operation terminal 20 in real time. Through this configuration, the operator can remotely operate mobile body 21 in real time.

Service provider terminal 10 may register a wallet corresponding to the service provider (a service provider wallet) with the plurality of license issuing devices 40 that manage a blockchain. Information about the service provider wallet is one example of service provider information that identifies the service provider.

Service provider terminal 10 may perform a process of assigning a plurality of mobile bodies 21 included in the remote system provided by the corresponding service provider to an operator registered in advance. Service provider terminal 10 may, for example, perform a process of issuing a license for remotely operating mobile body 21 to an operator and assigning mobile body 21 that can be operated with the issued license to the operator. There may be a plurality of types of licenses for remotely operating mobile body 21. For example, a plurality of types of licenses may be issued in accordance with the kind of mobile body 21, the size of mobile body 21, the remote operation skill level required for mobile body 21.

In this example, the remote operation skill level may define the number of mobile bodies that the operator can be in charge of remotely operating simultaneously. Basically, a mobile body can, for example, move autonomously without being remotely operated. A mobile body, for example, stops moving autonomously if the mobile body encounters a predetermined event in which the mobile body is unable to move autonomously, and enters a remote operation standby state. Since the duration for which a mobile body is in a remote operation standby state is shorter than the duration for which the mobile body moves autonomously, it is not likely that the period in which a mobile body is a remote operation standby state overlaps with the periods in which other mobile bodies are in a remote operation standby state. Therefore, an operator can be in charge of remotely operating a plurality of mobile bodies simultaneously in accordance with his or her remote operation skills.

For each of the plurality of types of licenses, the service provider defines a skill test for issuing the license of the corresponding type. A skill test includes an examination for identifying the skills needed to remotely operate mobile body 21 of the kind and the size corresponding to the skill test. In a skill test, for example, an operator taking the test is instructed to remotely operate predefined mobile body 21 along a moving route set in advance. Whether an operator has passed or failed a skill test is determined by a score calculated based on his or her operation history of remote operations.

Although only one service provider terminal 10 is illustrated in FIG. 1, there may be a plurality of service provider terminals 10. The number of service providers is not limited to one, and there may be a plurality of service providers. A plurality of service provider terminals 10 may be provided for each service provider.

According to the present embodiment, service provider terminal 10 may be, for example, a personal computer or a mobile terminal, such as a smartphone or a tablet.

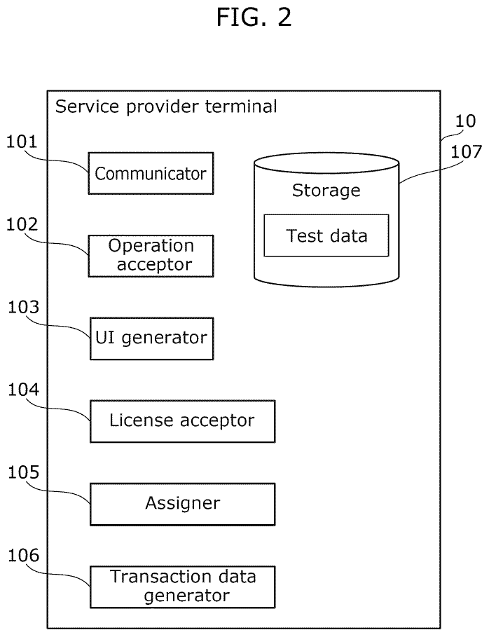

FIG. 2 is a drawing showing one example of a configuration of a service provider terminal according to the embodiment.

Service provider terminal 10 according to the present embodiment includes communicator 101, operation acceptor 102, user interface (UI) generator 103, license acceptor 104, assigner 105, transaction data generator 106, and storage 107.

Communicator 101 sends and receives information to and from another terminal (or device) via network N. In this example, such communication may be carried out through the transport layer security (TLS), and the encryption key for the TLS communication may be held in communicator 101.

Operation acceptor 102 accepts an operation, performed by an operator, that is represented by operation information received from operation terminal 20 by communicator 101. In other words, operation acceptor 102 successively accepts an operation performed by an operator via a UI of an application for remote operation by using operation terminal 20. An operation to be accepted is an operation for executing a control instruction for remotely operating mobile body 21. Operation acceptor 102 accepts an operation from an operator based on an input provided by the operator via a UI of an application for remote operation generated by UI generator 103, which will be described later. In a case in which service provider terminal 10 is equipped with a function of operation acceptor 102 as well, operation acceptor 102 may accept an operation directly from an operator. In other words, operation acceptor 102 may accept an operation from an operator via a separate terminal or may accept an operation from an operator directly. Based on an accepted operation, operation acceptor 102 generates a control signal for remotely operating mobile body 21 and transmits the generated control signal to mobile body 21 via communicator 101. In this manner, operation acceptor 102 obtains the operation history of operations performed by the operator via a UI of an application for remote operation.

UI generator 103 generates UI information representing a UI of an application for remote operation. UI information is transmitted to operation terminal 20 via communicator 101. UI generator 103 may generate, as the UI information, first UI information representing a first UI of an application that implements a test for issuing a license for remote operation. UI generator 103 may generate, as the UI information, second UI information representing a second UI of an application that implements a remote operation. In this example, the first UI and the second UI may differ from each other or may be identical to each other.

License acceptor 104 obtains license information that operation terminal 20 holds from operation terminal 20 via communicator 101, and identifies the type and the size of mobile body 21 and the remote operation skills corresponding to the license indicated by the obtained license information.

In accordance with the type and the size of mobile body 21 and the remote operation skills identified by license acceptor 104, assigner 105 assigns mobile body 21 to be remotely operated via operation terminal 20 associated with the license information. Of the plurality of types of mobile bodies 21, assigner 105, for example, assigns, as mobile body 21 to be operated, mobile body 21 that corresponds to the identified type and size of mobile body 21. Furthermore, assigner 105 may assign mobile bodies 21 in a number corresponding to the remote operation skills. With this configuration, the operator becomes permitted to remotely operate, of the plurality of mobile bodies 21, a mobile body that corresponds to the license information via operation terminal 20.

The plurality of mobile bodies 21 may have their moving routes set in advance by the service providers. In that case, of the plurality of mobile bodies 21, assigner 105 may assign, as mobile body 21 to be remotely operated, mobile body 21 the remote operation skills required by whose moving route are included in the remote operation skills identified based on the license information.

In this example, in a case in which an application that implements a test is being executed, service provider terminal 10 obtains operator information for identifying the operator of operation terminal 20 (i.e., an operator ID) from operation terminal 20. Furthermore, service provider terminal 10 obtains information representing the test that the operator is taking from operation terminal 20 and thus identifies test information for identifying the test. This test is a test approved in advance through a review conducted by an administrator. The test information may be stored in storage 107, which will be described later, with the test information associated with administrator information. Accordingly, as the test information is identified, the administrator information is identified. Furthermore, since service provider terminal 10 is capable of obtaining an operation history of operations performed on an application that implements a test, service provider terminal 10 can obtain a test result that includes the operation history.

Transaction data generator 106 generates first transaction data that includes a test result that includes an operation history of an operator who has taken a test, operator information of the operator, service provider information for identifying the service provider of service provider terminal 10, test information for identifying the test, and administrator information identified based on the test information. The first transaction data is first information. In this example, the test result may include a score calculated based on the operation history. A score may be calculated in service provider terminal 10. Transaction data generator 106 transmits the generated first transaction data to license issuing device 40 via communicator 101.

Storage 107 stores test data that defines various tests. The test data may include data representing an application that implements the test for remote operation described above. The test data may include test information and administrator information of each test.

Operation terminal 20 will be described next.

### Operation Terminal 20

Operation terminal 20 is one example of an operation terminal to be used by an operator. An operator performs an operation to remotely operate a mobile body. As has been described earlier, operation terminal 20 functions as a remote monitoring device of a mobile body. Specifically, operation terminal 20 accepts an operation from an operator and transmits, to a mobile body, a control signal representing an instruction for controlling the movement of the mobile body in accordance with an accepted operation. Furthermore, operation terminal 20 receives detection information detected by a plurality of kinds of sensors provided in a mobile body from the mobile body via wireless communication and presents the received detection information to the operator.

Operation terminal 20 may register a wallet corresponding to an operator (an operator wallet) with the plurality of license issuing devices 40 managing the blockchain. Information about an operator wallet is one example of operator information for identifying an operator.

According to the present embodiment, operation terminal 20 may be, for example, a personal computer or a mobile terminal, such as a smartphone or a tablet.

In this example, service provider terminal 10 may be equipped with the function of operation terminal 20. In other words, an operator may be able to remotely operate a mobile body with the use of service provider terminal 10.

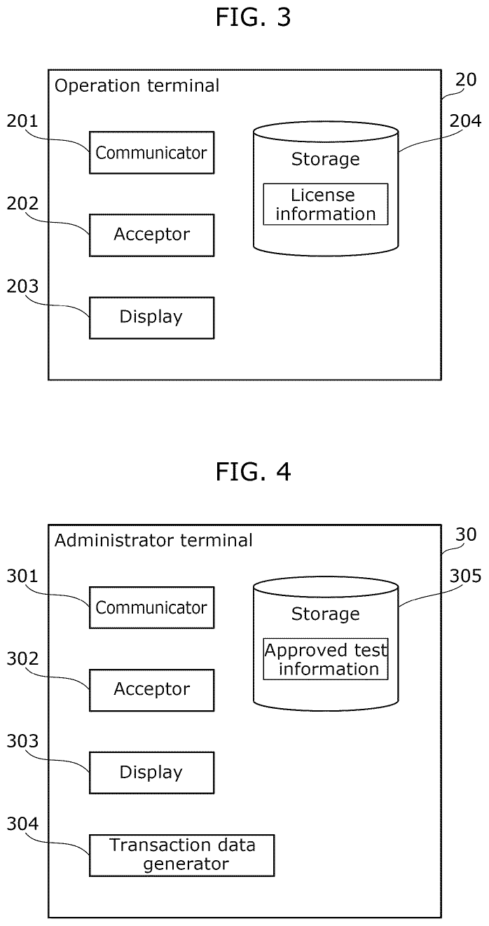

FIG. 3 is a drawing showing one example of a configuration of an operation terminal according to the embodiment.

Operation terminal 20 includes communicator 201, acceptor 202, display 203, and storage 204.

Communicator 201 sends and receives information to and from another terminal (or device) via network N. In this example, such communication may be carried out through the transport layer security (TLS), and the encryption key for the TLS communication may be held in communicator 201.

Acceptor 202 accepts an operation performed by an operator via a first UI of an application that implements a test for issuing a license for remote operation. Furthermore, acceptor 202 accepts an operation performed by an operation via a second UI of a second application for remote operation. Acceptor 202 transmits operation information representing the accepted operation to service provider terminal 10 via communicator 201. Acceptor 202 accepts an operation for instructing movement control in real time.

In this example, acceptor 202 may transmit the operation information directly to mobile body 21. In that case, acceptor 202 may transmit a copy of the operation information to service provider terminal 10. With this configuration, service provider terminal 10 can obtain an operation history of mobile body 21 from operation terminal 20.

Display 203 displays a first UI represented by first UI information or a second UI represented by second UI information. Display 203 presents detection information obtained from mobile body 21 to the operator of operation terminal 20 in real time. Display 203 is, for example, a display monitor.

Storage 204 may store license information for identifying a license held by an operator. When an operator has passed a specific test, operation terminal 20 may obtain license information representing the license from this specific test from license issuing device 40, and the obtained license information may be stored in storage 204. The license information may be stored with the license information associated with the operator information of the operator.

In this example, operation terminal 20 does not have to store the license information. Operation terminal 20 may, for example, obtain license information corresponding to the operator information from service provider terminal 10 when the operator has logged in to the remote operation system provided by service provider terminal 10 with the use of the operator information or obtain license information corresponding to the operator information from a separate terminal or device. The obtained license information may be stored in storage 204.

### Administrator Terminal 30

Administrator terminal 30 is one example of a terminal to be used by an administrator. An administrator manages licenses for remotely operating mobile bodies used by remote systems provided by respective service providers. An administrator is, for example, an organization that approves tests for issuing a plurality of types of licenses for remote operation. An administrator determines whether a skill test defined by a service provider is appropriate and, if the administrator determines that the skill test is appropriate, the administrator approves the skill test. For example, a skill test is approved when the remote operation skills of an operator determined to have passed a test included in the skill test are recognized to satisfy a predetermined standard. In other words, as an administrator approves a skill test, the operator holding the license issued based on this skill test is guaranteed to have the remote operation skills that meet or exceed a prescribed standard.

Furthermore, an administrator manages licenses for remote operation of a plurality of remote operation systems provided by a plurality of different service providers. Each license managed by an administrator is a license approved by the administrator, and the operators who hold these licenses are guaranteed to have the remote operation skills corresponding to their licenses that meet or exceed a prescribed standard.

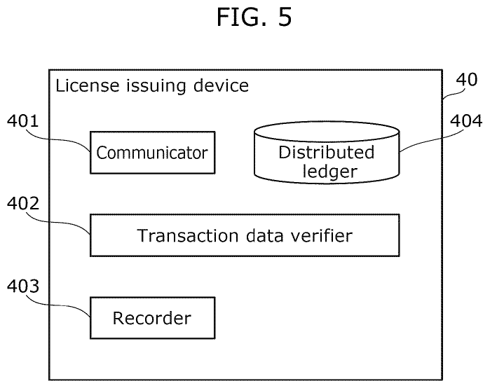

FIG. 4 is a drawing showing one example of a configuration of an administrator terminal according to the embodiment.

Administrator terminal 30 includes communicator 301, acceptor 302, display 303, transaction data generator 304, and storage 305.

Communicator 301 sends and receives information to and from another terminal (or device) via network N. In this example, such communication may be carried out through the transport layer security (TLS), and the encryption key for the TLS communication may be held in communicator 301.

Acceptor 302 accepts an input representing a result of a review conducted by an administrator regarding a test provided by a service provider. The input review result is stored in storage 305 as approved test information along with the test information for identifying the test. The approved test information includes review information for identifying the review based on which the test has been approved as being appropriate and review target information for identifying the test that has been reviewed in the review identified by the review information.

Display 303 displays a UI for accepting an input of a review result. Display 303 is, for example, a display monitor.

Transaction data generator 304 generates second transaction data that includes review information and review target information. Transaction data generator 304 transmits the generated second transaction data to license issuing device 40 via communicator 301.

Storage 305 stores approved test information.

### License Issuing Device 40

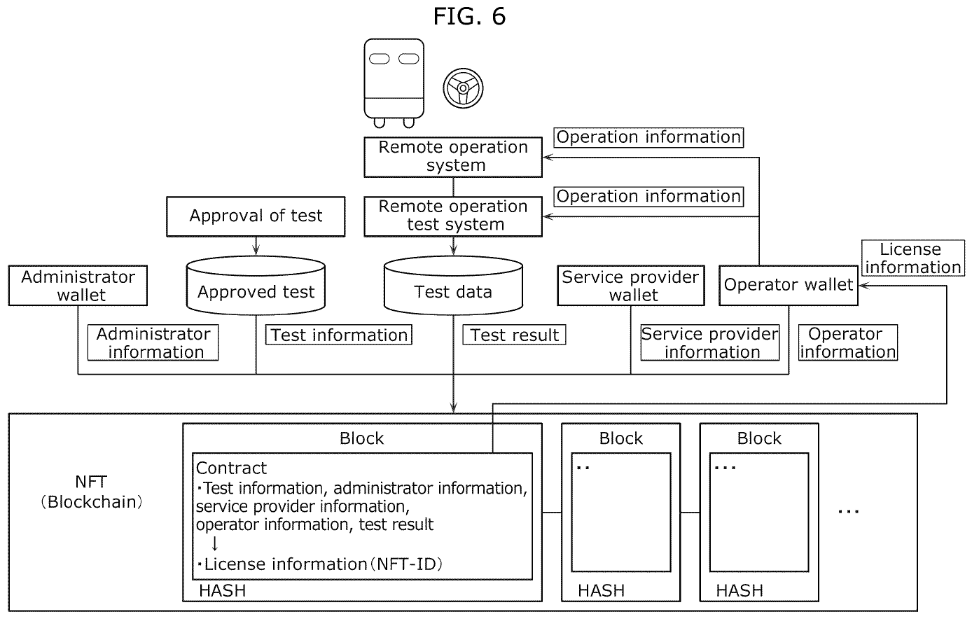

FIG. 5 is a drawing showing one example of a configuration of a license issuing device according to the embodiment.

License issuing device 40 includes communicator 401, transaction data verifier 402, recorder 403, and distributed ledger 404.

Communicator 401 sends and receives information to and from another terminal via network N. In this example, such communication may be carried out through the transport layer security (TLS), and the encryption key for the TLS communication may be held in communicator 401.

Transaction data verifier 402, in response to communicator 401 receiving transaction data, verifies the legitimacy of the transaction data. For example, transaction data verifier 402 checks whether an electronic signature generated in a proper technique is appended to transaction data that communicator 401 has received. In this example, this verification may be skipped. Here, transaction data that communicator 401 receives is either one of the first transaction data and the second transaction data.

Furthermore, transaction data verifier 402, along with other license issuing devices 40, executes a consensus algorithm for establishing a consensus with regard to the legitimacy of transaction data.

In this example, for the consensus algorithm, the Practical Byzantine Fault Tolerance (PBFT) algorithm or any other known consensus algorithms may be used. Examples of such known consensus algorithms include Proof of Work (PoW) or Proof of Stake (PoS). In a case in which the PBFT algorithm is used as the consensus algorithm, transaction data verifier 402 receives a report, from each of other license issuing devices 40, that indicates whether the transaction data has been verified successfully and determines whether the number of such reports has exceeded a predetermined number. Then, when the number of the reports has exceeded the predetermined number, transaction data verifier 402 may determine that the legitimacy of the transaction data has been verified through the consensus algorithm.

In response to confirming the legitimacy of the transaction data, transaction data verifier 402 records this transaction data into recorder 403.

According to the present embodiment, transaction data verifier 402 verifies the legitimacy of the first transaction data and the second transaction data that communicator 401 has received.

Recorder 403 records transaction data by storing the transaction data whose legitimacy has been verified by transaction data verifier 402 into distributed ledger 404 with the transaction data incorporated into a block. Recorder 403 generates a first block that includes the first transaction data and stores the generated first block in distributed ledger 404. Furthermore, recorder 403 generates a second block that includes the second transaction data and stores the generated second block in distributed ledger 404.

In this example, recorder 403 may include distributed ledger 404.

Distributed ledger 404 stores the first block that includes the first transaction data and the second block that includes the second transaction data. Distributed ledger 404 stores a blockchain. Distributed ledger 404 includes a first contract code (a smart contract) for generating license information based on the first transaction data. The first contract code is executed in response to the first block that includes the first transaction data being stored in the blockchain.

In response to the first contract code being executed, a process of generating license information and a process of outputting the license information are executed. In the process of generating license information, if the test result included in the first transaction data satisfies a predetermined standard, license information is generated for identifying the license that belongs to the operator identified by the operator information included in the first transaction data and that is for a remote operation corresponding to the test identified by the test information. The license information to be generated is, for example, a non-fungible token (NFT)-ID that identifies an NFT. In the process of outputting the license information, the generated license information is output. In the process of outputting the license information, for example, the generated license information is transmitted to operation terminal 20 identified by the operator information. With this configuration, operation terminal 20 can obtain license information from license issuing device 40.

In the process of generating license information, whether the test result included in the first transaction data satisfies a predetermined standard may be determined. In other words, the first contract code may include a smart contract for executing such a determination that is based on the predetermined standard. In this determination, for example, if the test result includes a score calculated based on an operation history, whether this score is higher than or equal to a reference value serving as the predetermined standard may be determined, and if the score is higher than or equal to the reference value, the test result may be determined to satisfy the predetermined standard. In this example, the operator may be regarded to have passed the test if the test result satisfies the predetermined standard, or the operator may be regarded to have failed the test if the test result fails to satisfy the predetermined standard.

In this example, the first contract code may further execute a transfer of a payment of the test fee for the test that the operator indicated by the operator wallet has taken from the account of the operator to the account of the administrator indicated by the administrator wallet. In other words, the first contract code may include a smart contract for executing a process of transferring the test fee associated in advance with the test that the operator has taken from the account of the operator to the account of the administrator. Furthermore, the first contract code may further execute a transfer of a payment of the test fee for the test that the operator indicated by the operator wallet has taken from the account of the operator to the account of the service provider indicated by the service provider wallet. In other words, the first contract code may include a smart contract for executing a process of transferring the payment of the test fee associated in advance with the test that the operator has taken from the account of the operator to the account of the service provider. In this example, the transfer of the payment executed by the first contract code may be made from the account of the operator to each of the account of the administrator and the account of the service provider, and, for example, a portion of the test fee may be paid to the account of the administrator and the remainder of the test fee may be paid to the account of the service provider. The test fee may include, for example but not limited to, the fee for issuing a license, the fee for issuing a certificate of certification, and the cost of gas.

Distributed ledger 404 may further include a second contract code for generating test information based on the second transaction data. The second contract code is executed in response to the second block that includes the second transaction data being stored in the blockchain.

In response to the second contract code being executed, a process of generating test information and a process of outputting the test information are executed. In the process of generating test information, test information is generated that is for identifying the test identified by the review target information included in the second transaction data and that indicates that the test has been approved. In the process of outputting the test information, the generated test information is transmitted to administrator terminal 30. With this configuration, administrator terminal 30 can obtain test information from license issuing device 40.

In management system 1, a plurality of different licenses may be issued by a plurality of service providers. Therefore, the following are conceivable. A first service provider issues a first license for a first remote operation. A second service provider issues a second license for a second remote operation of a type different from that of the first remote operation. A first remote system to be operated through the first remote operation is provided by the first service provider. A second remote system to be operated through the second remote operation is provided by the second service provider. In the process of generating license information, the predetermined standard is determined to have been satisfied if a first test result of a first test for issuing the first license satisfies a first standard. Furthermore, in the process of generating license information, the predetermined standard is determined to have been satisfied if a second test result of a second test for issuing the second license satisfies the first standard.

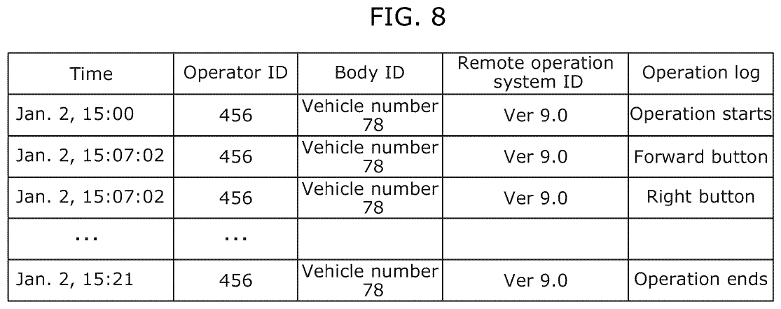

FIG. 7 is a drawing showing one example of a test result.

As shown in FIG. 7, a test result includes one or more items of operation information. In the example shown in FIG. 7, the test result includes, except at the start and the end of the test, operation information that corresponds to an operation that changes the score (i.e., an operation that results in point deduction). In this example, the test result may include operation information that corresponds to an operation that does not change the score (i.e., an operation that does not result in point deduction).

In the table shown in FIG. 7, each row corresponds to one item of operation information. Each item of operation information includes the time, the operator ID, a test event, and point deduction items 1 to n. The time indicates the time at which the corresponding operation information is generated. The operator ID indicates the ID that identifies the operator who has performed the operation indicated by the operation information. The operator ID is one example of the operator information. The test event includes, for example, the start of the test, the point deduction, and the end of the test. The start of the test indicates that the test has started, the point deduction indicates that an operation that results in point deduction has been performed, and the end of the test indicates that the test has ended. Point deduction items 1 to n indicate a point or points deducted in response to an operation subject to point deduction being performed. For example, FIG. 7 indicates that five points are deducted on point deduction item 2 at 15:07 on January 2nd. In calculating the score, the score of the test that the operator has taken is calculated as, using the test result, the total of the points to be deducted on all the point deduction items included in the test result is deducted from the perfect score.

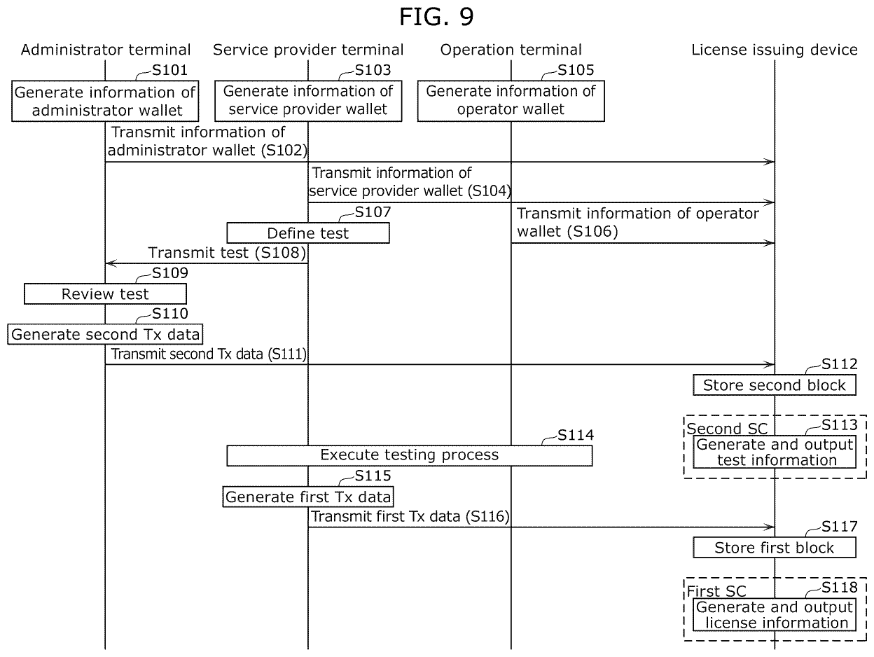

FIG. 8 is a drawing showing one example of an operation history.

As shown in FIG. 8, an operation history includes a plurality of items of operation information. In the table shown in FIG. 8, each row corresponds to one item of operation information. Each item of operation information includes the time, the operator ID, the body ID, the remote operation system ID, and an operation log. The time indicates the time at which the corresponding operation information is generated. The operator ID indicates the ID that identifies the operator who has performed the operation indicated by the operation information. The operator ID is one example of the operator information. The body ID indicates the ID that identifies the mobile body operated remotely. The remote operation system ID indicates the ID that identifies the remote operation system provided by a service provider. The operation log indicates an operation that the operation has input to operation terminal 20.

### 2. Operation and Other Matters of Management System

Next, an operation of the management system configured as described above will be described.

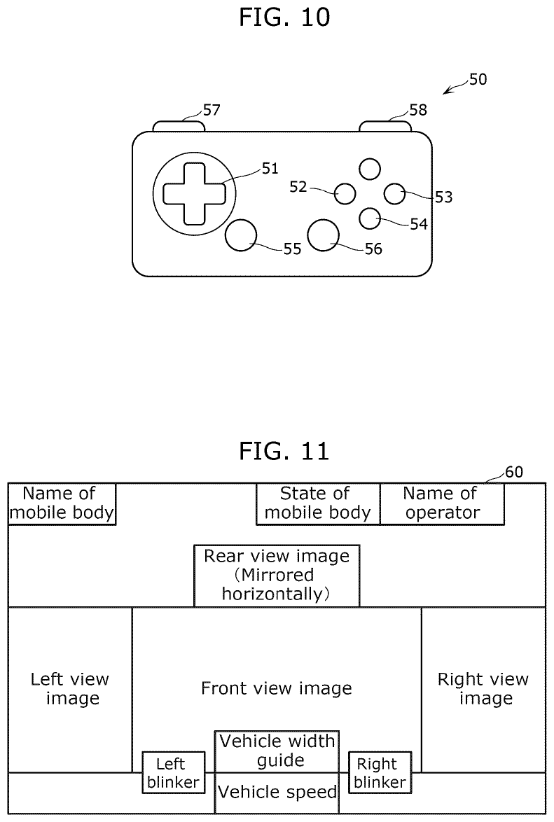

FIG. 9 is a sequence diagram showing one example of a license issuing process executed by the management system according to the embodiment.

Administrator terminal 30 accepts an input from the administrator and thus generates information representing an administrator wallet on the blockchain managed by the plurality of license issuing devices 40 (S101).

Administrator terminal 30 transmits the information representing the administrator wallet to license issuing devices 40 (S102). Through this operation, the information representing the administrator wallet is managed on the blockchain managed by license issuing devices 40.

Service provider terminal 10 accepts an input from the service provider and thus generates information representing a service provider wallet on the blockchain managed by the plurality of license issuing devices 40 (S103).

Service provider terminal 10 transmits the information representing the service provider wallet to license issuing devices 40 (S104). Through this operation, the information representing the service provider wallet is managed on the blockchain managed by license issuing devices 40.

Operation terminal 20 accepts an input from the operator and thus generates information representing an operator wallet on the blockchain managed by the plurality of license issuing devices 40 (S105).

Operation terminal 20 transmits the information representing the operator wallet to license issuing devices 40 (S106). Through this operation, the information representing the operator wallet is managed on the blockchain managed by license issuing devices 40.

Next, service provider terminal 10 accepts the definition of a test from the service provider (S107) and transmits the test represented by the accepted definition to administrator terminal 30 (S108).

Administrator terminal 30 reviews the content of the test received from service provider terminal 10 to determine whether the content is appropriate (S109).

Administrator terminal 30 generates second transaction data (denoted as “Second Tx data” in FIG. 9) that includes the review information and the review target information obtained through the review (S110) and transmits the generated second transaction data to license issuing device 40 (S111).

In response to receiving the second transaction data, license issuing device 40 executes a consensus algorithm along with other license issuing devices 40, generates a second block that includes the second transaction data, and stores the generated second block in distributed ledger 404 (S112).

In response to the second block being stored, license issuing device 40 executes a second smart contract (denoted as “Second SC” in FIG. 9) expressed by the second contract code and executes the process of generating test information and the process of outputting the generated test information (S113).

Next, operation terminal 20 and service provider terminal 10 execute a testing process (S114). In the testing process, specifically, in a case in which an application that implements the test is being executed, service provider terminal 10 obtains the operator information for identifying the operator of operation terminal 20 (i.e., the operator ID) from operation terminal 20. Furthermore, service provider terminal 10 obtains information representing the test that the operator takes from operation terminal 20 and thus identifies the test information for identifying the test. With this operation, a test that is based on a test scenario represented by the identified test information is executed. In the test, the operator is instructed to control a mobile body through remote operation and to control the mobile body to move along a moving route defined by the test. Then, service provider terminal 10 accumulates operation information received from operation terminal 20 during the test and generates an operation history.

Next, service provider terminal 10 generates first transaction data (denoted as “First Tx data” in FIG. 9) that includes the test result that includes the operation history of the operator who has taken the test, the operator information of the operator, the service provider information for identifying the service provider of service provider terminal 10, the test information for identifying the test, and the administrator information identified based on the test information (S115), and transmits the generated first transaction data to license issuing device 40 (S116).

In response to receiving the first transaction data, license issuing device 40 executes a consensus algorithm along with other license issuing devices 40, generates a first block that includes the first transaction data, and stores the generated first block in distributed ledger 404 (S117).

In response to the first block being stored, license issuing device 40 executes a first smart contract (denoted as “First SC” in FIG. 9) expressed by the fist contract code and executes the process of generating license information and the process of outputting the generated license information (S118).

### 3. Controller And UI

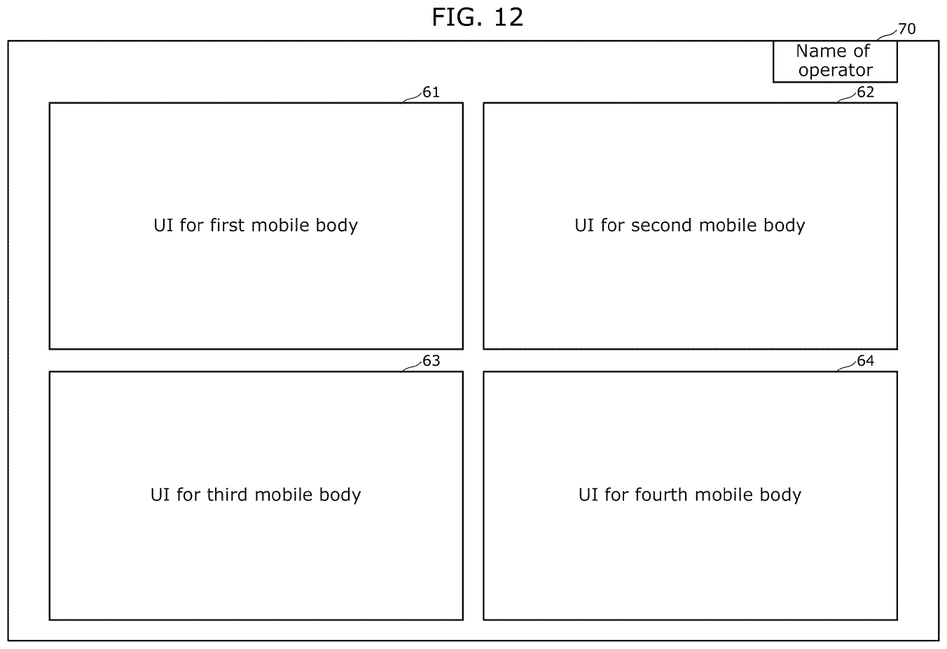

FIG. 10 is a drawing showing one example of a controller to be connected to an operation terminal.

Controller 50 is connected to operation terminal 20 and accepts an operation from an operator. In other words, controller 50 is one example of a hardware component that implements acceptor 202 of operation terminal 20.

Controller 50 includes directional pad 51, buttons 52 to 54, analog sticks 55 and 56, L button 57, and R button 58. Directional pad 51 may accept, for example, the start and the end of a remote operation. Button 52 may accept an operation for switching on or off a hazard warning lamp. Button 53 may accept an operation for causing mobile body 21 to make an emergency stop. Button 54 may accept an operation for causing mobile body 21 to emit a warning sound. Analog stick 55 may accept an operation for moving mobile body 21 in the front-back direction. Analog stick 56 may accept an operation for causing mobile body 21 to yaw to the right or the left. L button 57 may accept an operation for switching on or off the left blinker. R button 58 may accept an operation for switching on or off the right blinker.

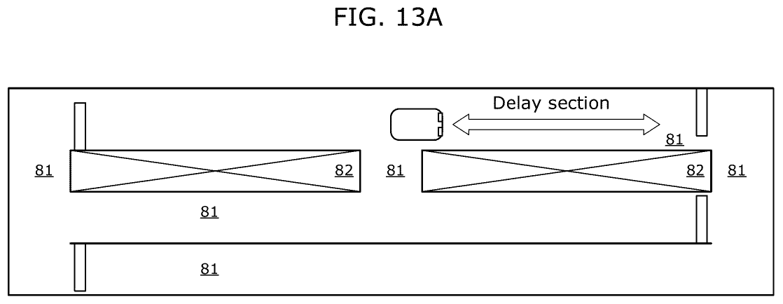

FIG. 11 is a drawing showing one example of a UI displayed on an operation terminal.

As shown in FIG. 11, UI 60 includes, for example but not limited to, the name of the mobile body, the state of the mobile body, the name of the operator, a rear view image, a left view image, a front view image, a right view image, the left blinker, the right blinker, the vehicle width guide, and the vehicle speed. A front view image captured by a front view camera of mobile body 21 is displayed in the center of UI 60, a left view image captured by a left view camera of mobile body 21 is displayed to the left of the front view image, and a right view image captured by a right view camera of mobile body 21 is displayed to the right of the front view image. Furthermore, an image captured by a rear view camera of mobile body 21 is displayed above the front view image with the image mirrored horizontally to serve as a rear view image. The left blinker indicates the on/off state of the left blinker of mobile body 21, and the right blinker indicates the on/off state of the right blinker of mobile body 21. Furthermore, the front view image displays the vehicle width guide indicating the width of mobile body 21. The vehicle speed displays the moving speed of mobile body 21, and the state of the mobile body displays whether mobile body 21 is in an autonomous control state or a remote operation state. The name of the mobile body displays the mobile body ID (the body ID) of mobile body 21, and the name of the operator displays the operator information of the operator operating operation terminal 20.

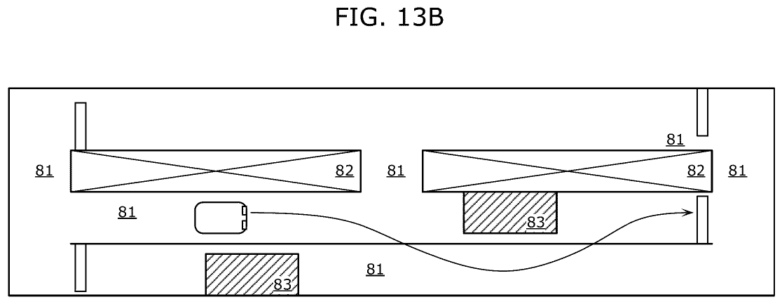

FIG. 12 is a drawing showing another example of a UI displayed on an operation terminal.

UI 70 shown in FIG. 12 is a UI displayed when an operator operates a plurality of (e.g., four) mobile bodies 21 simultaneously. UI 70 includes a plurality of UIs 61 to 64 corresponding to four mobile bodies 21. Each of UIs 61 to 64 is identical to UI 60 described with reference to FIG. 11 except that UIs 61 to 64 do not include the name of the operator.

### 4. Moving Route for Test

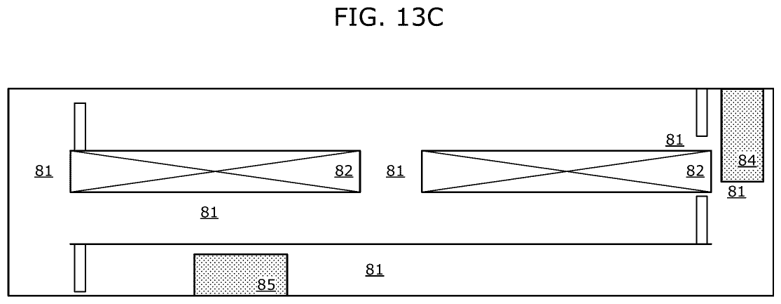

FIG. 13A is a drawing showing a first example of a moving route set in advance to be used for a test. FIG. 13B is a drawing showing a second example of a moving route set in advance to be used for a test. FIG. 13C is a drawing showing a third example of a moving route set in advance to be used for a test. FIG. 13D is a drawing showing a fourth example of a moving route set in advance to be used for a test. In FIG. 13A to FIG. 13D, traveling region 81 in which mobile body 21 can travel and non-traveling region 82 in which mobile body 21 cannot travel are defined.

In FIG. 13A, a delay section is indicated by the length of the white arrow, and it is defined that, if a delay in the operation occurs while mobile body 21 is moving within the delay section, the operator is to decelerate and stop mobile body 21. During a test, if an operator fails to decelerate and stop mobile body 21, when a delay has occurred in the delay section, a predetermined point or points are deducted. Furthermore, during a test, if an operator moves mobile body 21 off a predetermined route, a predetermined point or points are deducted. In this example, when a test is administered, the reproducibility of the test may be enhanced by creating a delay, for example but not limited to, by artificially reducing the available bandwidth in the network set at the location where the test is administered. Furthermore, in a case in which mobile body 21 is equipped with a function of automatically detecting an increase in the delay and decelerating and stopping, if an operator successfully recognizes that that function has worked and mobile body 21 has decelerated and stopped, the predetermined point or points do not need to be deducted.

FIG. 13B indicates that parked vehicle 83 is stopped in traveling region 81 and whether an operator can move mobile body 21 smoothly (e.g., within a predetermined time) along a route that avoids parked vehicle 83. During a test, if the operator fails to move mobile body 21 within a predetermined time, a predetermined point or points are deducted.

FIG. 13C indicates that the operator is set to park mobile body 21 within regions 84 and 85 on the designated locations. For example, the operator may be set to park mobile body 21 in region 84 first and then move mobile body 21 to region 85 to park it there. During a test, if an operator fails to park mobile body 21 within regions 84 and 85, a predetermined point or points are deducted. Furthermore, during a test, if an operator fails to park mobile body 21 within a predetermined time, a predetermined point or points are deducted.

FIG. 13D indicates that the operator is to cause mobile body 21 to travel along a figure-eight route in traveling region 81 as indicated by the arrow. During a test, if an operator fails to move mobile body 21 within a predetermined time, a predetermined point or points are deducted. Furthermore, during a test, if an operator moves mobile body 21 off a predetermined route, a predetermined point or points are deducted.

### 5. Advantageous Effects and Other Matters

The license issuing method according to the present embodiment is a license issuing method to be executed by one license issuing device 40 that issues a license for remote operation of mobile body 21 to an operator of mobile body 21. The license issuing method includes obtaining first information that includes a test result, operator information, service provider information, administrator information, and test information; when the test result included in the first information satisfies a predetermined standard, generating license information for identifying the license for the remote operation that corresponds to the test identified by the test information; and issuing the license by outputting the license information. The test result includes an operation history of an application that implements the test for issuing the license for the remote operation. The operator information is information for identifying the operator. The service provider information is information for identifying a service provider that provides a remote system for the mobile body. The administrator information is information for identifying an administrator that conducts a review to determine whether the test is appropriate and issues the license. The test information is information to identify the test approved through the review by the administrator. The license is a license issued to the operator identified by the operator information included in the first information.

According to this configuration, if the test result of the test approved through the review by the administrator satisfies the predetermined standard, the license is issued to the operator who has taken the test. Therefore, this configuration makes it easier to issue a license for remote operation that satisfies a prescribed or higher standard of operation skills and that can be used for other remote operation systems as well.

Furthermore, in the license issuing method according to the present embodiment, the license issuing method is executed by each of a plurality of license issuing devices 40 that includes one license issuing device 40. The plurality of license issuing devices 40 each manage a plurality of distributed ledgers 404. The first information is first transaction data. The plurality of distributed ledgers 404 each include a first contract code for generating the license information based on the first transaction data. In the generating of the license information, in response to the first transaction data being obtained, the license information is generated by executing the first contract code included in a first distributed ledger (distributed ledger 404) managed by one license issuing device 40.

According to this configuration, since the license information is generated as the first contract code is executed, this configuration can prevent the license information from being generated in a fraudulent manner.

Furthermore, in the license issuing method according to the present embodiment, the license issuing method further includes obtaining second transaction data that includes review information for identifying the review that has approved the test as being appropriate and review target information for identifying the test reviewed in the review identified by the review information, and generating test information for identifying the test identified by the review target information based on the second transaction data. The plurality of distributed ledgers 404 each include a second contract code for generating the test information based on the second transaction data. In the generating of the test information, in response to the second transaction data being obtained, the test information is generated by executing the second contract code included in the first distributed ledger.

According to this configuration, since the test information is generated as the second contract code is executed, this configuration can prevent the test information from being generated in a fraudulent manner.

Furthermore, in the license issuing method according to the present embodiment, the first contract code further executes a transfer of a payment of a test fee for the test that the operator has taken from an account of the operator to an account of the administrator. Here, the first contract code may further include a code that executes a transfer of a payment of a portion of the test fee from the account of the operator to an account of the service provider.

According to this configuration, since the transfer of the payment of the test fee is executed as the first contract code is executed, this configuration makes it possible to execute the transfer of the payment of the test fee without fraud.

Furthermore, the license issuing method according to the present embodiment further includes generating a first block that includes the first transaction data, and storing the first block in the plurality of distributed ledgers 404.

According to this configuration, since the first block that includes the first transaction data is stored in distributed ledgers 404, this configuration can prevent the first information that includes the test result from being altered.

Furthermore, the license issuing method according to the present embodiment further includes generating a second block that includes the second transaction data, and storing the second block in the plurality of distributed ledgers 404.

According to this configuration, since the second block that includes the license information is stored in distributed ledgers 404, this configuration can prevent the license information from being altered.

Furthermore, in the license issuing method according to the present embodiment, a first license for first remote operation and a second license for second remote operation of a type different from that of the first remote operation can be issued. A first remote system to be operated in the first remote operation is provided by a first service provider. A second remote system to be operated in the second remote operation is provided by a second service provider. In the generating of the license information, the predetermined standard is determined to have been satisfied if a first test result of a first test for issuing the first license satisfies a first standard. The predetermined standard is determined to have been satisfied if a second test result of a second test for issuing the second license satisfies the first standard.

According to this configuration, the first license and the second license can be managed in an integrated manner.

Furthermore, the license issuing method according to the present embodiment further includes successively accepting, via an operation terminal, an operation for the remote control input by the operator via a user interface (UI) of the application, and generating an operation history by recording a plurality of operations successively accepted.

According to this configuration, the operation history that is based on the plurality of operations received from the operation terminal can be generated, and whether the predetermined standard is satisfied can be determined based on the test result that includes the generated operation history.

Furthermore, in the license issuing method according to the present embodiment, the test result includes a score calculated based on the operation history. If the score is higher than or equal to a reference value serving as the predetermined standard, the test result is determined to have satisfied the predetermined standard.

According to this configuration, by determining whether the score calculated based on the operation history exceeds the reference value, whether the test result satisfies the predetermined standard can be determined.

Furthermore, the license issuing method according to the present embodiment further includes obtaining the license information from operation terminal 20. The license issuing method according to the present embodiment further includes permitting a remote operation of, of a plurality of mobile bodies, a mobile body that corresponds to the license information via the operator terminal.

This configuration makes it easier to permit the remote operation of the mobile body that corresponds to the license information.

Meanwhile, operation terminal 20 according to the present embodiment is connected, via network N, to license issuing device 40 that issues a license for remote operation of mobile body 21 to an operator of mobile body 21. Operation terminal 20 includes a receiver (communicator 201), acceptor 202, and a transmitter (communicator 201). The receiver receives, from license issuing device 40, first UI information representing a first UI of a first application that implements a test for issuing the license for the remote operation. Acceptor 202 accepts a first operation for the remote operation input by the operator via the first UI. The transmitter transmits operation information representing the first operation accepted by acceptor 202 to license issuing device 40. The receiver receives the license information for identifying the license for the remote operation to be issued when the test result that includes the operation history that is based on the operation information satisfies a predetermined standard.

According to this configuration, since the operation information representing the first operation on the first application that implements the test for issuing the license is transmitted and the license information that is based on the operation information is received, the license can be obtained with ease.

Furthermore, operation terminal 20 according to the present embodiment further includes storage 204. Storage 204 stores the license information for identifying the license that belongs to the operator and that is for the remote operation corresponding to the test. The transmitter further transmits the license information to the license issuing device. The receiver receives, from the license issuing device, second UI information representing a second UI of a second application for the remote operation of, of a plurality of mobile bodies, a mobile body that corresponds to the license information. Acceptor 202 accepts a second operation for the remote operation input by the operator via the second UI. The transmitter transmits operation information representing the second operation accepted by acceptor 202 to license issuing device 40.

According to this configuration, since the remote operation of the mobile body that corresponds to the license information issued to the operator is permitted, this configuration allows, with ease, the operator to operate an appropriate mobile body according to the license that the operator has obtained.

### 6. Variations and Other Matters

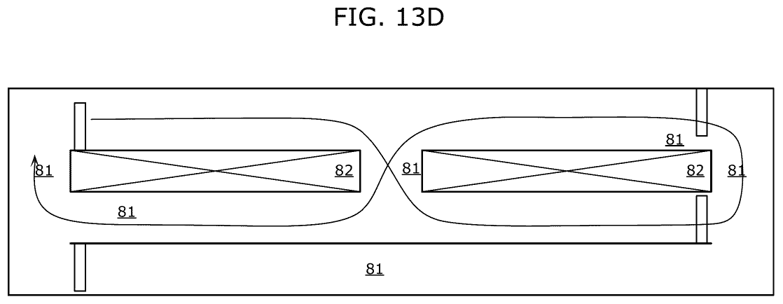

(1) In the examples described above, the blockchain is managed by the plurality of license issuing devices 40 in management system 1 according to the foregoing embodiment, but this is not a limiting example. As shown in FIG. 14, management system 1 may be implemented in a configuration in which management system 1 does not manage the blockchain, and management system 1 may include, for example, single license issuing device 40.

In that case, license issuing device 40 performs a process of issuing license information in response to obtaining first information that includes a test result, operator information, service provider information, administrator information, and test information. The process of issuing the license information is identical to the process of generating license information and outputting the generated license information as described according to the embodiment.
(2) According to the foregoing embodiment, the process of the review by an administrator may include the following processes. A service provider transmits, to administrator terminal 30 via service provider terminal 10, characteristics information that represents the characteristics of the mobile body and the characteristics of the remote operation system and test definition information that defines the test course representing the moving routes used in the test and the point deduction items. Through this process, the test definition information is submitted to the administrator from the service provider.

The administrator appoints an expert in remote operation of mobile body 21 as a review committee member. The appointed review committee member takes in the characteristics of the mobile body and the characteristics of the remote operation system based on the characteristics information and conducts a review to determine whether the test can appropriately access the skills based on the test definition information. In the review, the result may be determined collegially by a plurality of review committee members.

The review committee member ID that identifies a review committee member, the date when the review is conducted, the characteristics information, and the test definition information may be recorded on a blockchain (e.g., Ethereum) in the form of a smart contract. Here, the information about the review described above may be saved among the administrators with a record of the review documented, for example, on paper, and the information may be disclosed to an organization if a request is made by the organization.

In this example, as described with reference to FIG. 10 and FIG. 11, the characteristics information may include a shared screen layout on a UI for remote operation or a shared operation method as specified by an administrator. Furthermore, as described with reference to FIG. 13A to FIG. 13D, the test definition information may include a shared test course specified by an administrator. Furthermore, the characteristics information may include a list of mobile bodies that an operator who has passed a test can operate and information on the maximum number of mobile bodies that such an operator can operate simultaneously.
(3) According to the foregoing embodiment, a movable range that is based on a test record may be limited. A test defined by a service provider may include a test in which an operator is instructed to operate mobile body 21 (e.g., a remotely operated small vehicle) so as to cross a crosswalk at an intersection with a traffic light or to cross an intersection without a traffic light. At this point, the test record may include a test record that indicates whether the operator has successfully executed an operation in which the operator stops mobile body 21 before crossing the intersection to check for vehicles on the right and left and then mobile body 21 starts crossing the intersection. Furthermore, the test record may include a test record that indicates whether the operator has successfully executed an operation in which, after mobile body 21 being operated has reached a position before a crosswalk while the traffic light for pedestrians is green, mobile body 21 waits for the light to turn red to ensure enough time for mobile body 21 to finish crossing the crosswalk while the traffic light is green, and then the operator instructs mobile body 21 to start moving again at the timing at which the traffic light has turned green again.

Furthermore, the test record may include a test record that indicates whether the operator has successfully executed an operation in which the operator causes mobile body 21 to travel on a sidewalk that is sufficiently wide and as wide as two meters or more or to travel on a sidewalk that is relatively narrow and is less than two meters wide. Moreover, the test record may include a test record that indicates whether the operator has successfully executed an operation in which mobile body 21 stops and yields to a pedestrian or the like when mobile body 21 encounters a pedestrian, a bicycle, a wheelchair, or the like while traveling on a relatively narrow sidewalk.

Furthermore, the test record may include a test record that indicates whether the operator has successfully executed an operation in which, when mobile body 21 travels on a road without pedestrian-vehicle separation, mobile body 21 travels on the right side of the road.

The test result may include a plurality of the test records described above.
(4) According to the foregoing embodiment, the remote operation system may obtain license information of an operator and may operate as described below.

In an area in which the remote operation system is adopted and mobile body 21 is in use, mobile body 21 may be assigned to an operator as described below based on the test record of the operator.

In a case in which the operator has a test record indicating that the operator has operated mobile body 21 on a wide sidewalk, the operation of mobile body 21 planned to travel on a width sidewalk may be assigned to that operator. Meanwhile, in a case in which the operator has a test record indicating that the operator has operated mobile body 21 on a narrow sidewalk, the operation of mobile body 21 planned to travel on a wide sidewalk as well as a narrow sidewalk may be assigned to that operator. Meanwhile, in a case in which the operator has a test record indicating that the operator has operated mobile body 21 to cross a crosswalk, the operation of mobile body 21 planned to cross a crosswalk may be assigned to that operator. Meanwhile, in a case in which the operator has a test record indicating that the operator has operated mobile body 21 to cross an intersection with a traffic light, the operation of mobile body 21 planned to travel to cross an intersection with a traffic light may be assigned to that operator. Meanwhile, in a case in which the operator has a test record indicating that the operator has operated mobile body 21 to travel on a road without pedestrian-vehicle separation, the operation of mobile body 21 planned to travel on a road without pedestrian-vehicle separation may be assigned to that operator.

Furthermore, the remote operation system may assign mobile body 21 to an operator with a specific test record when mobile body 21 has reached a position before a location where that specific test record is required, or the remote operation system may scan all the conceivable traveling routes in advance and permit only an operator with a test record required for the entire traveling routes to operate mobile body 21.

Furthermore, depending on the test record of an operator, the traveling route of mobile body 21 may be changed to meet the test record.
(5) According to the foregoing embodiment, the test result of the first test stored in distributed ledger 404 may be referred to in the second test. The first test and the second test are as described above according to the foregoing embodiment. For example, in the second test, with reference to an operation history obtained when a delay has been extended in the test result of the first test, and in consideration of the similarity (or the difference) in the mechanism for controlling a delay between a vehicle in the first remote system and a vehicle in the second remote system, if the mechanisms are similar (if the difference is smaller than a predetermined difference), the test result in which the operator has passed the first test may be recognized as the passing in the test result of the delay extension test in the second test. In this example, the test result of the first test for the first remote system may be used in the second test in consideration of the similarity not only in the operation history obtained when a delay has been extended but also in any operation histories.

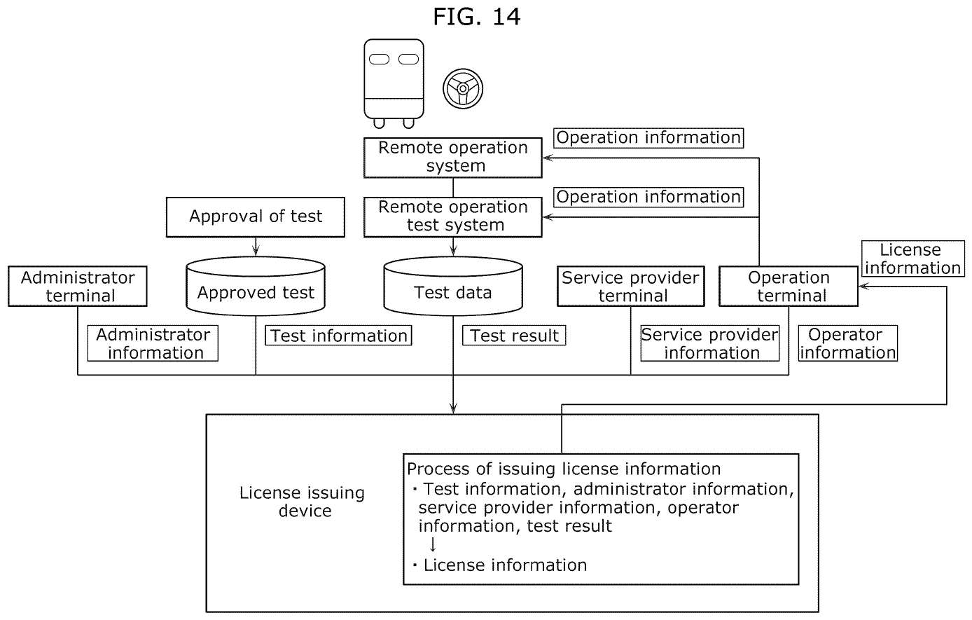

In a case in which a vehicle of a new model (referred to as a new vehicle below) is introduced as a vehicle to be used in the first remote system, in the test for an operator to operate this new vehicle, a test result in which the operator has operated an old vehicle may be referred to. In this case as well, for example, in the test in which the operator operates the new vehicle, the operation history obtained when a delay has been extended among the test results in which the operator has operated an old vehicle may be referred to, and if the mechanisms of the delay control are equivalent between the old vehicle and the new vehicle, the test result obtained when the operator has passed the test for the old vehicle may be recognized as the passing in the test result of the delay extension test in the test for the new vehicle taken by the operator. In this example, the test result of the test for the old vehicle may be used for the test for the new vehicle in consideration of the similarity not only in the operation history obtained when a delay has been extended but also in any operation histories.
(6) According to the foregoing embodiment, a test may be administered in a simulated environment, and if the test result from that test satisfies the passing standard, a provisional license may be issued. An operator to whom a provisional license has been issued and who holds the provisional license may be permitted to remotely operate a vehicle in a remote system under the supervision of a certified operator who has passed a test for that remote system (or an examiner who gives the test to the operator). In this example, being under the supervision of a certified operator is a state in which the certified operator is next to (close to) the operator, a state in which the certified operator is available to communicate remotely with the operator, or a state in which the certified operator is available to intervene in the remote operation of the vehicle being operated by the operator. For example, as shown in FIG. 15, in a case in which an operator holding a provisional license is to operate vehicle 21 in the remote system with the use of controller 50 while looking at UI 60, a certified operator or the examiner may be in a state in which the certified operator or the examiner is also able to operate vehicle 21 in the remote system with the use of controller 50 while looking at UI 60. In this example, if the certified operator or the examiner operates vehicle 21, the operation performed by the certified operator or the examiner takes precedence even if the operator holding the provisional license performs an operation.

Furthermore, an additional skill may be recognized to an operator holding a provisional license, based on an operation record obtained while that operator operates a vehicle in a remote system under the supervision of a certified operator. Specifically, if an operator holding a provisional license has not taken a test for an operation of crossing a crosswalk or has failed such a test, that operator may perform the operation of crossing a crosswalk under the supervision of a certified operator, and if the operation result satisfies the passing standard for that test, this operation result is admitted as the test result, and the operator may be recognized to have passed the operation of crossing a crosswalk. In this example, whether the operator has passed or failed the test for this operation may be determined with the use of the operation records of not only the operation of crossing a crosswalk but any operations for which the operator has not taken a test or has failed a test.
(7) The blockchain according to the foregoing embodiment will be further described.

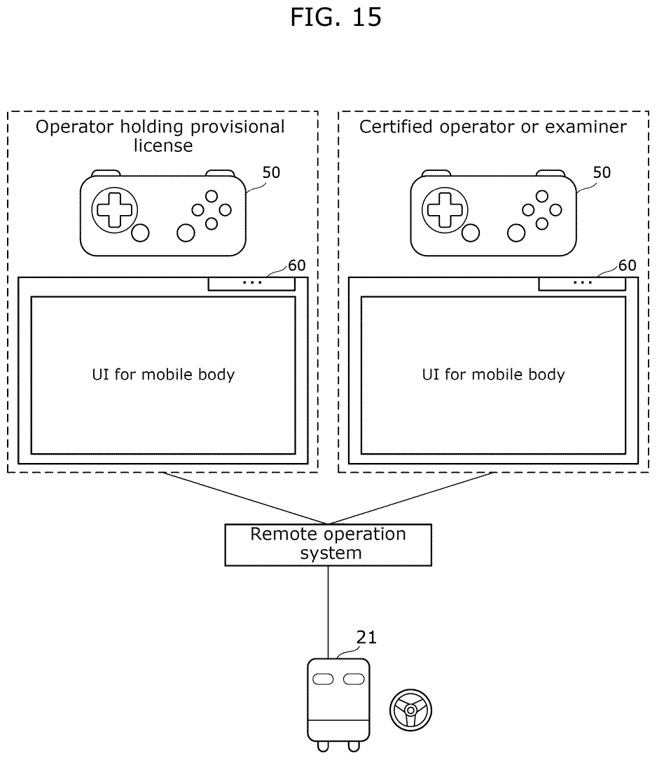

FIG. 16 is an explanatory diagram showing a data structure of the blockchain.

The blockchain is composed of blocks, each serving as a recording unit of the blockchain, connected in a chain-like manner. Each of the blocks includes a plurality of items of transaction data and the hash value of the block immediately preceding it. Specifically, block B2 includes the hash value of block B1 preceding block B2. Then, the hash value calculated based on a plurality of items of transaction data included in block B2 and the hash value of block B1 is incorporated in block B3 as the hash value of block B2. In this manner, as the content of the preceding block is incorporated in the form of a hash value and as the blocks are connected in a chain-like manner, an alteration of the recorded transaction data can be prevented effectively.

If past transaction data is modified, the hash value of the modified block takes a value different from the value held before the modification. Therefore, in order to make the altered block appear as if no alteration has been made, all the blocks following the altered block need to be recreated, and such an operation is very difficult in reality. The use of this property can ensure that a blockchain is extremely hard to alter.

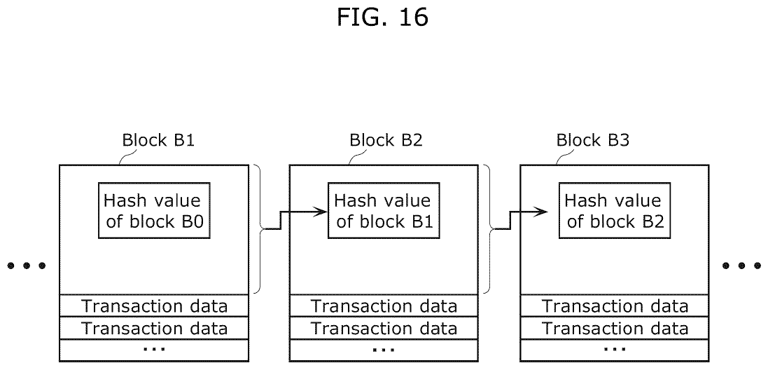

FIG. 17 is an explanatory diagram showing a data structure of transaction data.

The transaction data shown in FIG. 17 includes transaction body P1 and electronic signature P2. Transaction body P1 is the data body included in the transaction data. Electronic signature P2 is generated as the hash value of transaction body P1 is signed with a signing key of the creator of the transaction data, or more specifically, as the hash value of transaction body P1 is encrypted by a private key of the creator.

Since the transaction data includes electronic signature P2, it is substantially impossible to alter the transaction data. This property can keep the transaction body from being altered.

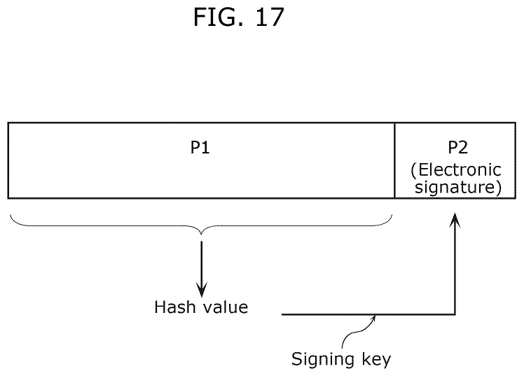

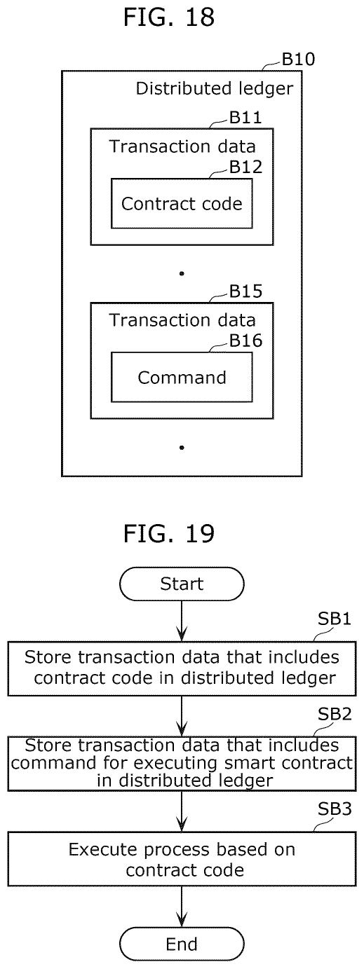

FIG. 18 is an explanatory diagram showing transaction data that pertains to the execution of a smart contract. FIG. 19 is an explanatory diagram showing a process that pertains to the execution of the smart contract.

With reference to FIG. 18 and FIG. 19, a series of processes pertaining to the execution of a smart contract using a distributed ledger will be described.

At step SB1, a node stores, into distributed ledger B10, transaction data B11 that includes contract code B12 in which the processes of a smart contract are written. For example, the node obtains transaction data B11, for example, by receiving transaction data B11 from an information processing device through communication or by the node itself generating transaction data B11, and stores obtained transaction data B11 into distributed ledger B10. Step SB1 is performed before the smart contract is executed.

At step SB2, the node stores, into distributed ledger B10, transaction data B15 that includes command B16 that executes the smart contract. For example, the node receives transaction data B15 from an information processing device through communication and stores received transaction data B15 into distributed ledger B10.

At step SB3, in response to transaction data B15 that includes command B16 being stored into distributed ledger B10 at step SB2, the node reads out contract code B12 from distributed ledger B10 and executes the processes based on contract code B12. The result of the processes above may be incorporated into transaction data and stored in distributed ledger B10.

Through the series of processes described above, in response to receiving transaction data B15 that includes command B16 that executes the smart contract, the distributed ledger system executes the processes according to command B16 automatically (in other words, without human intervention), and thus the processes can be executed with high efficiency (in other words, at high speed or in a short period of time). The highly efficient execution of the processes provides an advantageous effect of reduced power consumption. Furthermore, since the execution does not involve any human intervention, alteration of information by a human or fraudulent or artificial errors can be prevented. Furthermore, since the result of the processes executed in that manner is stored into the blockchain, this configuration makes it practically impossible to alter the result of the processes.

According to the foregoing embodiment, the constituent elements may each be implemented by a dedicated piece of hardware or through the execution of a software program suitable for the corresponding constituent element. The constituent elements may each be implemented as a program executing unit, such as a central processing unit (CPU) or a processor, reads out a software program recorded on a recording medium, such as a hard disk or a semiconductor memory, and executes the software program. Herein, the software that implements the license issuing method and so forth according to the foregoing embodiment is a program that causes a computer to execute each step included in the flowcharts shown in the drawings.

### 7. Other Matters

Herein, cases such as the following are also encompassed by the present disclosure.
(1) Each device described above is specifically a computer system that includes, for example, a microprocessor, a read only memory (ROM), a random access memory (RAM), a hard disk unit, a display unit, a keyboard, and a mouse. The RAM or the hard disk unit stores a computer program. As the microprocessor operates in accordance with the computer program, each device implements its function. In this example, the computer program includes a plurality of sets of command codes providing instructions to a computer to implement predetermined functions.
(2) A part or the whole of the constituent elements included in each of the devices described above may be implemented by a single system large scale integration (LSI) circuit. A system LSI circuit is an ultra-multifunctional LSI circuit manufactured by integrating a plurality of components on a single chip and is specifically a computer system that includes, for example, a microprocessor, a ROM, or a RAM. The RAM stores a computer program. As the microprocessor operates in accordance with the computer program, the system LSI circuit implements its function.
(3) A part or the whole of the constituent elements included in each of the devices described above may be implemented by an IC card that can be attached to or detached from each device or by a stand-alone module. The IC card or the module is a computer system that includes a microprocessor, a ROM, a RAM, and so on. The IC card or the module may include the ultra-multifunctional LSI circuit described above. As the microprocessor operates in accordance with the computer program, the IC card or the module implements its function. The IC card or the module may be tamper resistant.
(4) The present disclosure may be implemented in the form of the method described above. Moreover, the present disclosure may be implemented in the form of a computer program that implements such a method by a computer or in the form of digital signals representing such a computer program.

Furthermore, the present disclosure may be implemented in the form of a computer readable recording medium having the computer program or the digital signals described above recorded thereon, and examples of such a computer readable recording medium include a flexible disk, a hard disk, a CD-ROM, a magneto-optical (MO) disc, a digital versatile disc (DVD), a DVD-ROM, a DVD-RAM, a Blue-ray (BD) (registered trademark) disc, and a semiconductor memory. Moreover, the present disclosure may be implemented in the form of the digital signals recorded on any of the aforementioned recording media.

Furthermore, According to the present disclosure, the computer program or the digital signals described above may be transmitted via an electric communication circuit, a wireless or wired communication circuit, a network such as the internet being a representative example, data broadcast, or the like.

Furthermore, the present disclosure may be implemented in the form of a computer system provided with a microprocessor and a memory, the memory may store the computer program, and the microprocessor may operate in accordance with the computer program.

Furthermore, the program or the digital signals may be recorded onto a recording medium, which may then be transported, or the program or the digital signals may be transmitted via any of the networks described above. Thus, the program or the digital signals may be executed by a separate stand-alone computer system.
(5) The foregoing embodiment and variations may be combined.

### INDUSTRIAL APPLICABILITY

The present disclosure finds its use as a license issuing method and so forth that make it easier to issue a license for remote operation that satisfies a prescribed or higher standard of operation skills and that can be used for other remote operation systems as well.

1. A license issuing method to be executed by a license issuing device that issues a license for remote operation of a mobile body to an operator of the mobile body, the license issuing method comprising:
obtaining first information that includes:
a test result that includes an operation history of an application that implements a test for issuing the license for the remote operation;
operator information for identifying the operator;
service provider information for identifying a service provider that provides a remote system for the mobile body;
administrator information for identifying an administrator that conducts a review to determine whether the test is appropriate and issues the license; and
test information for identifying the test approved through the review by the administrator;
when the test result included in the first information satisfies a predetermined standard, generating license information for identifying the license that is issued to the operator identified by the operator information included in the first information and is for the remote operation that corresponds to the test identified by the test information; and
issuing the license by outputting the license information.

2. The license issuing method according to claim 1, wherein
the license issuing method is executed by each of a plurality of license issuing devices that include the license issuing device,
the plurality of license issuing devices each manage a plurality of distributed ledgers,
the first information is first transaction data,
the plurality of distributed ledgers each include a first contract code for generating the license information based on the first transaction data, and
in the generating of the license information, in response to the first transaction data being obtained, the license information is generated by executing the first contract code included in a first distributed ledger managed by the license issuing device among the plurality of distributed ledgers.

3. The license issuing method according to claim 2, further comprising:
obtaining second transaction data that includes review information for identifying the review through which the test has been approved as being appropriate, and review target information for identifying the test subjected to the review identified by the review information; and
generating the test information for identifying the test identified by the review target information, based on the second transaction data, wherein
the plurality of distributed ledgers each include a second contract code for generating the test information based on the second transaction data, and
in the generating of the test information, in response to the second transaction data being obtained, the test information is generated by executing a second contract code included in the first distributed ledger.

4. The license issuing method according to claim 2, wherein
the first contract code further executes a transfer of a payment of a test fee for the test taken by the operator from an account of the operator to at least one of an account of the administrator or an account of the service provider.

5. The license issuing method according to claim 2, further comprising:
generating a first block that includes the first transaction data, and storing the first block in the plurality of distributed ledgers.

6. The license issuing method according to claim 3, further comprising:
generating a second block that includes the second transaction data, and storing the second block in the plurality of distributed ledgers.

7. The license issuing method according to claim 1, wherein
a first license for first remote operation and a second license for second remote operation of a type different from a type of the first remote operation are issuable by the license issuing method,
a first remote system for the first remote operation is provided by a first service provider,
a second remote system for the second remote operation is provided by a second service provider, and
in the generating of the license information, the predetermined standard is determined to be satisfied when a first test result of a first test for issuing the first license satisfies a first standard, and the predetermined standard is determined to be satisfied when a second test result of a second test for issuing the second license satisfies the first standard.

8. The license issuing method according to claim 1, further comprising:
successively accepting, via an operator terminal, an operation for the remote operation input by the operator via a user interface (UI) of the application; and
generating the operation history by recording a plurality of operations obtained in the successively accepting.

9. The license issuing method according to claim 8, wherein
the test result includes a score calculated based on the operation history, and
when the score is higher than or equal to a reference value serving as the predetermined standard, the test result is determined to satisfy the predetermined standard.

10. The license issuing method according to claim 8, further comprising:
obtaining the license information from the operator terminal; and
permitting the remote operation of a mobile body that corresponds to the license information among a plurality of mobile bodies, the remote operation being performed via the operator terminal.

11. An operation terminal to be connected, via a network, to a license issuing device that issues a license for remote operation of a mobile body to an operator of the mobile body, the operation terminal comprising:
a receiver that receives, from the license issuing device, first user interface (UI) information representing a first UI of a first application that implements a test for issuing the license for the remote operation;
an acceptor that accepts a first operation for the remote operation input by the operator via the first UI; and
a transmitter that transmits, to the license issuing device, operation information representing the first operation accepted by the acceptor, wherein
the receiver receives license information for identifying the license for the remote operation issued when a test result including an operation history that is based on the operation information satisfies a predetermined standard.

12. The operation terminal according to claim 11, further comprising:
a storage that stores license information for identifying the license that is issued to the operator and is for the remote operation corresponding to the test, wherein
the transmitter further transmits the license information to the license issuing device,
the receiver receives, from the license issuing device, second UI information representing a second UI of a second application for the remote operation of the mobile body corresponding to the license information among a plurality of mobile bodies,
the acceptor accepts a second operation for the remote operation input by the operator via the second UI, and
the transmitter transmits, to the license issuing device, operation information representing the second operation accepted by the acceptor.

13. A non-transitory computer-readable recording medium having recorded thereon a program for causing a computer to execute the license issuing method according to claim 1.
